(19) United States
(12) Patent Application Publication
(10) Pub. No.: US 2024/0293849 A1
(43) Pub. Date: Sep. 5, 2024

(54) Self-cleaning control system for pet drinking device based on Internet-of-Things

(71) Applicant: MIAOMIAOHEI (SHENZHEN) CO., LTD., Shenzhen, Guangdong (CN)

(72) Inventor: Jiawen He, Shenzhen, Guangdong (CN)

(21) Appl. No.: 18/044,621

(22) PCT Filed: Dec. 30, 2022
(86) PCT No.: PCT/CN2022/143828

§ 371 Date: Mar. 9, 2023

(30) Foreign Application Priority Data
Jul. 8, 2022 (CN) 202210801968.9

(51) Int. Cl. B08B 3/08; B08B 13/00; G06T 7/62; G06T 7/73

(52) U.S. Cl. CPC B08B 3/08; B08B 13/00; G06T 7/62; G06T 7/75

(57) ABSTRACT

An automatic cleaning control system of pet drinking device based on Internet-of-Things operates by providing the cleaning devices, the cleaning monitoring devices and the cleaning processing devices in the feeding dish of the pet drinking device, and collecting images of the surface of the feeding dish in real time with a cleaning monitoring terminal provided on the feeding dish of the pet drinking device, analyzing the cleaning index corresponding to the feeding dish based on collected images of the surface of the feeding dish, and conducting self-cleaning of the feeding dish, intelligent and automatic cleaning of the feeding dish in the pet drinking device is realized, compared with manual cleaning.

### TECHNICAL FIELD

The present invention relates to the technical field of cleaning control of pet drinking devices, specifically a self-cleaning control system for pet drinking device based on Internet-of-Things.

### BACKGROUND TECHNOLOGY

With the development of the society, economy and acceleration of urbanization, independence, individualization and the aging of the population is increasingly outstanding, leisure, consumption and emotional entrustment of citizens appear diversified. Pet feeding has become an important part of leisure and emotion entrustment of more and more people. While more and more people feed animals, pet drinking has become more and more emphasized, how to have the pet drink healthy water at any time and place has been an issue concerned by pet owners, in this circumstance, pet drinking devices appeared, with which water is sprinkled automatically, circulation and filtration of water as per certain programs can be preset, so that drinking demand of the pet can be efficiently promised.

However, upon long term usage, a lot of encrustation is precipitated on the drinking dish of the pet drinking device, on the other aspect, during drinking, the pet may leave foreign matters such as hair, food residues etc. in the drinking dish, upon long time precipitation, many bacteria and eggs are generated in the drinking dish, wellbeing of the pet is threatened, so it becomes very important to conduct daily cleaning of the drinking dish of the pet drinking device.

Currently, daily cleaning work of the pet drinking device is done manually, primarily by a cleaner, and cleaning time and areas are quite limited, specifically, cleaning may not be done timely, sometimes some dirt may have not been cleaned, so the cleaning effects are not good so that it is difficult to promise drinking health of the pet effectively.

### SUMMARY OF THE INVENTION

To address the foregoing technical problem, the present invention is realized by the foregoing technical solution:

A self-cleaning control system for pet drinking device based on Internet-of-Things, comprising:
a cleaning device setting module, configured to provide a cleaning device on a feeding dish of the pet drinking device and a control terminal thereof;
a cleaning monitoring terminal setting module, configured to provide a cleaning monitor terminal, wherein the cleaning monitor terminal comprises a ball-shaped monitor camera;
a cleaning device setting module, configured to provide a cleaning processing device next to the feeding dish of the pet drinking device;
a feeding dish pollution parameter monitoring module, configured to conduct image acquisition for a surface of the feeding dish with the cleaning monitoring terminal provided on the feeding dish of the pet drinking device, identifying types of dirt, dirty areas and spatial coordinates of the dirty areas;
a feeding dish cleaning index analysis module, configured to analyze a cleaning index of the feeding dish corresponding to pollution parameters of the surface of the feeding dish;
a control database, configured to store appearance features of dirt corresponding to all types of dirt, store cleaning types corresponding to all types of dirt, store a range of cleaning difficulty coefficients corresponding to all cleaning types; store cleaning water sprinkling amounts corresponding to all cleaning types for water cleaning and store required cleaning agent amounts and cleaning water sprinkling amounts corresponding to all cleaning types for chemical cleaning;
a feeding dish self-cleaning control terminal, configured to choose a predetermined cleaning device and cleaning demand for the feeding dish according to the cleaning index corresponding to the cleaning dish so as to control the predetermined cleaning device to conduct self-cleaning and open the cleaning processing device next to the feeding dish for drainage after cleaning.

In a preferred technical solution of the present invention, the cleaning device comprises a cleaning liquid storage container and a water box, wherein a control terminal corresponding to the cleaning agent storage container is a control valve, a control terminal corresponding to the water box is a water sprinkler, wherein the water sprinkler is a sprinkler with water sprinkling angle adjustable.

In a preferred embodiment, the cleaning device comprises a drainage port and a drainage water box.

In a preferred embodiment, identifying the pollution parameters existing on the surface of the feeding dish according to images of the surface of the feeding dish comprises:
S1: focusing on the dirty area in the collected images of the surface of the feeding dish, extracting the appearance features of the dirt and a contour of the dirt;
S2: matching the extracted appearance features of the dirt and the contour of the dirt with all types of dirt in the control database and matching the types of dirt existing on the surface of the feeding dish;
S3: acquiring the dirty area existing on the surface of the feeding dish from the extracted contour of the dirt;
S4: building a three-dimensional rectangular coordinate system on the surface of the feeding dish by a predetermined building method of the three-dimensional rectangular coordinate system and locating spatial coordinates of the dirty area in the images of the surface of the feeding dish based on the three-dimensional rectangular coordinate system.

In a preferred technical solution, the cleaning index comprises cleaning types, cleaning difficulty levels and sprinkling angles, wherein the cleaning types comprise water cleaning and chemical cleaning.

In a preferred technical solution, analyzing the cleaning index corresponding to the feeding dish based on the pollution parameters on the surface of the feeding dish comprises the following steps:
Step 1: extracting types of dirt from the pollution parameters, matching the types of dirt with all cleaning types corresponding to all types of dirt stored in the control database and obtaining the cleaning types corresponding to the feeding dish;
Step 2: extracting the dirty area from the pollution parameters, extracting an area of the surface of the feeding dish from the images of the surface of the feeding dish, calculating the cleaning difficulty coefficient corresponding to the feeding dish by a cleaning difficulty coefficient calculation formula with the dirty area and the area of the surface of the feeding dish

$$Cleaning difficulty coefficient = \frac{dirty area}{area of the surface of the feeding dish} ;$$

Step 3: comparing the cleaning difficulty coefficient with the range of the cleaning difficulty coefficients corresponding to the all cleaning difficulty levels in the control database and obtaining consequently the cleaning difficulty level corresponding to the feeding dish;
Step 4: locating coordinates of an installation position of a water sprinkler based on the three-dimensional rectangular coordinate system, extracting spatial coordinates of the dirty area from the pollution parameters, analyzing desired sprinkling degrees of the water sprinkler to the dirty area according to coordinates of the installation position of the water sprinkler and the spatial coordinates of the dirty area, recording the same as a desired cleaning sprinkling degree, wherein an analysis process of corresponding desired cleaning sprinkling degrees Follows the following steps:
Step 41: calculating a sprinkling distance between the water sprinkler and the dirty area according to the coordinates of the installation position of the water sprinkler and the spatial coordinates of the dirty area, and the sprinkling distance is marked as l;
Step 42: taking as a starting point the installation position of the water sprinkler, drawing an installation horizontal line parallel to an axis x, projecting a position of the dirty area to the installation horizontal line, obtaining a projection position of the position of the dirty area on the installation horizontal line, marking the same as the projection position of the dirty area, obtaining coordinates of the projection position of the dirty area based on the three-dimensional rectangular coordinate system;
Step 43: calculating a projection distance of the position of the dirty area based on the coordinates of the position of the dirty area and the coordinates of the projection position of the dirty area, and marking the projection distance as h;
Step 44: forming a rectangular triangle with the installation position of the water sprinkler, the position of the dirty area and the projection position of the dirty area, calculating desired cleaning sprinkling angle based on the rectangular triangle, wherein a calculation formula of the desired cleaning sprinkling angle is

$$θ = arcsin \frac{h}{l} ,$$

θ is the desired cleaning sprinkling angle.
   In a preferred embodiment of the present invention, selecting a predetermined cleaning device and a desired cleaning amount corresponding to the feeding dish according to the cleaning index corresponding to the feeding dish comprises the following steps:
(1) Extracting cleaning types from the cleaning index, matching the cleaning types with the predetermined cleaning devices corresponding to all cleaning types, and selecting the predetermined cleaning device for the feeding dish;
(2) Extracting the cleaning difficulty level from the cleaning index, when the cleaning type corresponding to the feeding dish is water cleaning, the desired cleaning sprinkling amount is a water sprinkling amount, comparing the cleaning difficulty level with the desired water sprinkling amount corresponding to all cleaning difficulty levels for water cleaning stored in the control database, selecting the desired water sprinkling amount corresponding to the present cleaning difficulty level; if the cleaning type corresponding to the feeding dish is chemical cleaning, the desired cleaning amount comprises a cleaning agent usage amount and a desired water sprinkling amount, at this time, comparing the desired cleaning agent usage amount and the desired water sprinkling amount corresponding to all cleaning difficulty levels, and further obtaining the desired cleaning agent usage amount and the desired water sprinkling amount corresponding to the present cleaning difficulty level.

In a preferred technical solution of the present invention, the desired cleaning devices corresponding to the predetermined cleaning types comprise specifically at least one water storage box for water cleaning and at least one cleaning agent storage box and at least one water storage box for chemical cleaning.

In a preferred technical solution of the present invention, controlling the predetermined cleaning device to execute specific control methods corresponding to self-cleaning comprises specifically, starting the control terminal corresponding to the predetermined cleaning devices according to the desired cleaning device corresponding to the feeding dish, controlling a usage amount of the desired cleaning device so as to fulfill the cleaning demand, and controlling the sprinkling angle of the water sprinkler so as to comply with the desired cleaning sprinkling angle.

In a preferred technical solution of the present invention, the system comprises further an intelligent drainage warning module, configured to provide a siren on the pet drinking device, in the meanwhile, installing a liquid level sensor in the drainage box, monitoring in real time height of a liquid level in the drainage box, and comparing the same with a predetermined warning liquid level, and if at any moment the liquid level is bigger than the predetermined warning liquid level, starting the siren to send warning.

Compared with the prior art, the present invention has the following advantages:
1. In the present invention, by providing the cleaning devices, the cleaning monitoring devices and the cleaning processing devices in the feeding dish of the pet drinking device, and collecting images of the surface of the feeding dish with a cleaning monitoring terminal provided on the feeding dish of the pet drinking device, analyzing the cleaning index corresponding to the feeding dish based on collected images of the surface of the feeding dish, and conducting self-cleaning of the feeding dish, intelligent and automatic cleaning of the feeding dish in the pet drinking device is realized, compared with manual cleaning, on one hand, manual cleaning pressure is relieved, on the other hand, no foreign interference is required, limitations on cleaning time and cleaning areas are eliminated, targeted self-cleaning of the feeding dish can be realized in real time, timely and targeted cleaning of the feeding dish can be improved efficiently, cleaning effects are enhanced for certain degree and drinking health of pets can be promised.
2. In the present invention, when conducting automatic cleaning to the feeding dish in the pet drinking device, by building different cleaning types corresponding to different dirty types, self-cleaning of the dirt in the surface of the feeding dish can be realized by choosing corresponding cleaning types based on the dirty types on the surface of the feeding dish, therefore, appropriate cleaning types can be chosen intelligently based on actual pollution conditions of the feeding dish, targeted cleaning of the feeding dish can be realized, compared with unified cleaning with water, configuration of the cleaning types and flexibility of the cleaning configurations improved adaptivity of the cleaning methods to the actual polluted conditions, which is of high utility, and can not only improve cleaning efficiency of the polluted area, but also improve cleaning effects of the polluted area, and occurrence of insufficient cleaning due to cleaning with water only can be efficiently avoided.

### BRIEF DESCRIPTION OF DRAWINGS

Drawings are given to illustrate the present invention to a further extent, however, embodiments in the drawings do not in any way construe limitations to the present invention, for those of ordinary skill in the art, without paying inventive effort, other drawings can be obtained with the following drawings.

FIG. 1 is a schematic diagram showing connection between modules in the system according to the present invention;

FIG. 2 is a structural schematic diagram showing the cleaning device of pet drinking device according to the present invention; and

FIG. 3 is a schematic diagram showing construction of the three-dimensional rectangular coordinate system according to the present invention.

### EMBODIMENTS

Hereinafter the technical solutions in the present invention will be described clearly and completely in conjunction with the drawings provided in the embodiments of the present invention, apparently, the embodiments disclosed here are only some of the embodiments of the present invention, rather than all. All other embodiments obtained by those of ordinary skill in the art without paying creative effort fall into the protection scope of the present invention.

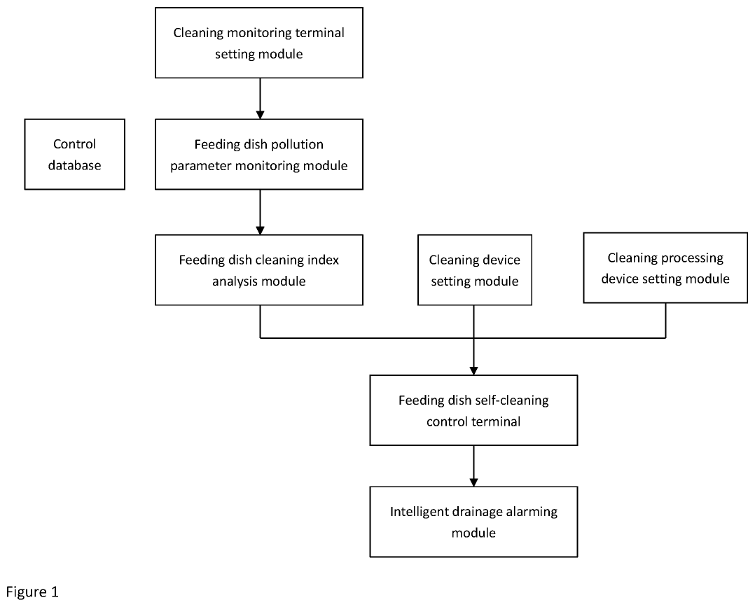

With reference to FIG. 1, a self-cleaning control system of pet drinking device based on Internet-of-Things, comprises a cleaning device setting module, a cleaning monitoring terminal setting module, a cleaning processing device setting module, a feeding dish pollution parameter monitoring module, a feeding dish cleaning index analysis module, a control database, a feeding dish self-cleaning control terminal and an intelligent drainage warning module.

Wherein the cleaning monitoring terminal setting module is connected with the feeding dish pollution parameter monitoring module, the feeding dish pollution parameter monitoring module is connected with the feeding dish cleaning index analysis module, the feeding dish cleaning index analysis module, the cleaning device setting module and the cleaning processing device setting module are connected with the cleaning dish self-cleaning control terminal, the feeding dish self-cleaning control terminal is connected with the intelligent drainage warning module, and the control database is respectively connected with the feeding dish pollution parameter monitoring module and the feeding dish cleaning index analysis module.

The cleaning device setting module is configured to set cleaning devices and corresponding control terminals on a feeding dish of the pet drinking device, the cleaning devices comprise at least a cleaning agent storage box and at least a water storage box, wherein the control terminal corresponding to the at least one cleaning agent storage box comprises at least one control valve, the control terminal corresponding to the at least one water storage box comprises at least one water sprinkler, and the at least one water sprinkler comprises a sprinkler with an adjustable sprinkling angle.

The cleaning monitoring terminal setting module is configured to set the cleaning monitoring terminal on the feeding dish of the pet drinking device, wherein the cleaning monitoring terminal is a ball-shaped monitor camera.

It shall be noted that, as the ball-shaped monitor camera can rotate freely, by using the ball-shaped monitor camera the feeding dish can be monitored in full aspects.

The cleaning processing device setting module is configured to provide a cleaning processing device next to the feeding dish of the pet drinking device, wherein the cleaning processing device comprises a drainage port and a drainage box.

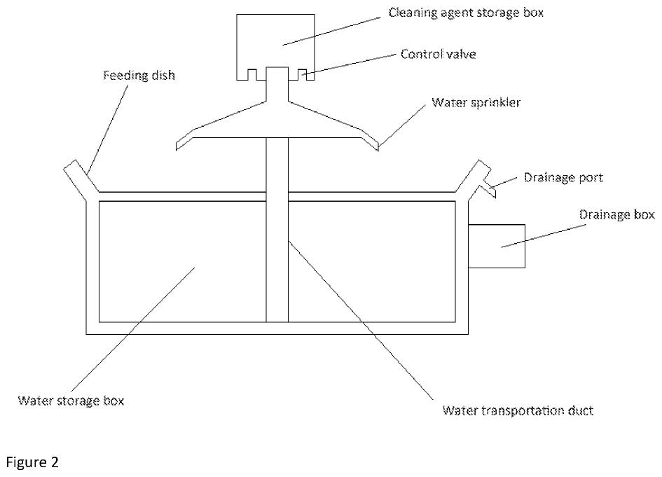

Configuration of the cleaning devices, the cleaning monitoring device and the cleaning processing device is shown in FIG. 2.

The feeding dish pollution parameter monitoring module is configured to use the cleaning monitoring terminal provided on the feeding dish of the pet drinking device for acquisition of images of a surface of the feeding dish, identify pollution parameters existing on the surface of the feeding dish according to the images of the surface of the feeding dish, wherein the pollution parameters comprise types of dirt, dirty areas and spatial coordinates of the dirty areas.

Identifying the pollution parameters existing on the surface of the feeding dish comprises the following steps:
S1: focusing the images of the surface of the feeding dish on the dirty area, extracting from the dirty area appearance features and a contour of the dirt, wherein the appearance features of the dirt comprise colors, appearances and structures of the dirt and shapes of the dirt etc.;
S2: matching the extracted appearance features of the dirt with the appearance features of the dirt corresponding to all types of dirt stored in the control database, knowing the type of dirt existing on the surface of the feeding dish, wherein the types of dirt include not are not limited to incrustant, hair, food residues, dust, oil stain.
S3: obtaining an area of the dirt existing on the surface of the feeding dish from the extracted contours of the pollution;
S4: building a three-dimensional rectangular coordinate system on the surface of the feeding dish by a predetermined way to establish a three-dimensional rectangular coordinate system, and locating the coordinates of the dirty area in the image of the surface of the feeding dish based on the built three-dimensional rectangular coordinate system.

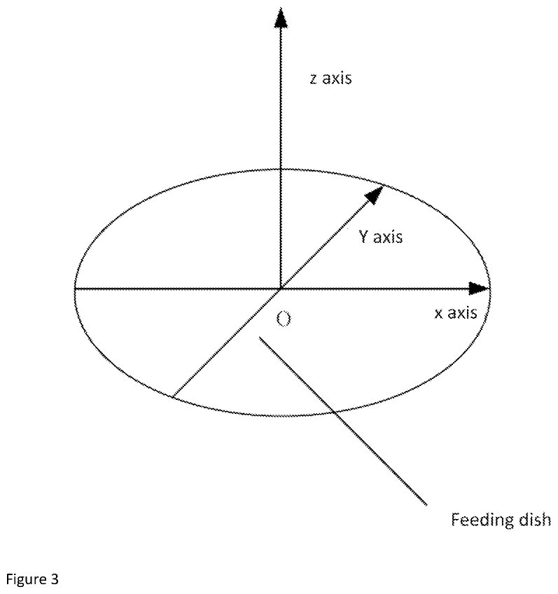

It shall be noted that, with reference to FIG. 3, the way to build the three-dimensional rectangular coordinate system is to use a center of the feeding dish as an origin of coordinates o, two perpendicular diameters as an axis x and an axis y, and a line perpendicular to a plane xoy as an axis z.

The feeding dish clean index analysis module is configured to analyze a clean index of the feeding dish based on the pollution parameter of the surface of the feeding dish, wherein the clean index comprises cleaning types, cleaning difficulty levels and cleaning sprinkling angles, wherein the cleaning types comprise water cleaning and chemical cleaning.

In the present invention, the purpose of providing cleaning difficulty levels is to choose appropriate cleaning levels depending on the cleaning difficulty levels so as to complete cleaning in one time and reduce the probability of cleaning for another time.

Wherein analyzing the cleaning index corresponding to the feeding dish based on the pollution parameter of the surface of the feeding dish is done as per the following steps:
Step 1: extracting types of dirt from the pollution parameter, matching the same with the cleaning types corresponding to all types of dirt stored in the control database and obtaining the cleaning type corresponding to the feeding dish;
Step 2: extracting the area of dirt from the pollution parameter, extracting a surface area of the feeding dish from the image of the surface of the feeding dish, calculating the cleaning difficulty coefficient with the dirty area and the surface area of the feeding dish as per a formula

$$cleaning difficulty coefficient = \frac{dirty area}{area of the surface of the feeding dish} ,$$

obtaining the cleaning difficulty coefficient corresponding to the feeding dish, wherein the bigger the dirty area is, the higher the cleaning difficulty coefficient is;
Step 3: comparing the cleaning difficulty coefficient corresponding to the feeding dish with a range of the cleaning difficulty coefficients corresponding to all cleaning difficulty levels in the control database, selecting the cleaning difficulty level corresponding to the feeding dish;
Step 4: locating the installation position coordinates of the water sprinkler based on the built three-dimensional rectangular coordinate system, extracting spatial coordinates of the dirty area from the pollution parameters, obtaining the desired sprinkling angle of the water sprinkler for the dirty area based on the installation position coordinates and spatial coordinates of the dirty area, marking the same as desired cleaning sprinkling angle, wherein an analysis process of the desired cleaning sprinkling angle is executed as per the following steps:

Step 41: calculating a sprinkling distance of the water sprinkler to the dirty area based the installation position coordinates of the water sprinkler and the spatial coordinates of the dirty area, marking the same as l, wherein a calculation formula of the corresponding sprinkling distance is l=\sqrt{(xᵢₙₛₜ−s_{dirt})²+(yᵢₙₛₜ−y_{dirt})²+(zᵢₙₛₜ−z_{dirt})²}, wherein xᵢₙₛₜ, yᵢₙₛₜ, and zᵢₙₛₜ are respectively coordinates of the installation position of the water sprinkler on the axis x, axis y and axis z, x_{dirt}, y_{dirt} and z_{dirt} are respectively coordinates of the position of the dirty area on the axis x, the axis y and the axis z;
Step 42: taking as a starting point the installation position of the water sprinkler, drawing an installation horizontal line parallel to the axis x, projecting the position of the dirty area on the installation horizontal line, obtaining a projected position of the position of the dirty area on the installation horizontal line, marking the same as the projected position of the dirty area, and obtaining coordinates of the projected position of the dirty area based on the built three-dimensional rectangular coordinate system;
Step 43: calculating the projection distance of the position of the dirty area based on the spatial coordinates of the dirty area and the coordinates of the projection position of the dirty area, marking the same as h;
Step 44: building a rectangular triangle with the installation position of the water sprinkler, the position of the dirty area and the projection position of the dirty area, calculating the desired cleaning sprinkling angle based on the built rectangular triangle, wherein a calculation formula of the desired cleaning sprinkling angle is

$$θ = arcsin \frac{h}{l} ,$$

wherein θ stands for the desired cleaning sprinkling angle.

The control database is configured to store appearance features of the dirt corresponding to all types of dirt, store the cleaning types corresponding to all types of dirt, store the range of the cleaning difficulty coefficients corresponding to all cleaning difficulty levels, store the desired clean water sprinkling amount corresponding to all cleaning difficulty levels of water cleaning and store the desired cleaning agent usage amount and the desired clean water sprinkling amount corresponding to all cleaning difficulty levels of chemical cleaning. Exemplarily, the cleaning type corresponding to hair, food residues and dust is water cleaning and the cleaning type corresponding to incrustant and oil stain is chemical cleaning.

Wherein the feeding dish self-cleaning control terminal is configured to select a predetermined cleaning device and cleaning amount according to the cleaning index corresponding to the feeding dish, comprising specifically the following steps:
(1) Extracting the cleaning types from the cleaning index, matching the cleaning types with the cleaning device corresponding to the predetermined cleaning types, matching the cleaning device corresponding to the feeding dish, wherein the cleaning device corresponding to water cleaning is a water storage box, and the cleaning device corresponding to chemical cleaning is a cleaning agent storage box and a water storage box, as the chemical agent serves to remove stains and clean water is used for washing to achieve cleaning;
(2) Extracting the cleaning difficulty levels from the cleaning index, if the cleaning type for the feeding dish is water cleaning, the desired cleaning amount is desired water sprinkling amount, at this time, comparing the cleaning difficulty level with the desired cleaning water sprinkling amount corresponding to all cleaning difficulty levels for water cleaning stored in the control database, so as to select the desired water sprinkling amount corresponding to the present cleaning difficulty level, if the cleaning type for the feeding dish is chemical cleaning, the desired cleaning amount comprises the required cleaning agent amount and the required water sprinkling amount, at this time, comparing the cleaning difficulty level with the required cleaning agent amount and the required water sprinkling amount corresponding to all cleaning difficulty levels for chemical cleaning stored in the control database, so as to select the required cleaning agent amount and the required water sprinkling amount corresponding to the present cleaning difficulty level.

In embodiments of the present invention, when conducting automatic cleaning of the feeding dish in the pet drinking device, by building all types of cleaning and the cleaning types corresponding to all types of pollution, adaptive cleaning types for the types of dirt in the surface of the feeding dish can be chosen for self-cleaning operations, so as to choose intelligently appropriate cleaning types based on actual pollution conditions of the feeding dish, targeted cleaning of the feeding dish can be realized, compared with cleaning only with water, configuration and flexible selection of the cleaning types have improved adaptiveness of the cleaning method to the actual pollution condition, which is of high utility, and cannot only improve cleaning efficiency of the polluted area, but also improve cleaning effects of the dirty area and insufficient cleaning due to cleaning with water only can be efficiently avoided.

After selecting the cleaning device and the required cleaning amount, the self-cleaning control terminal of the feeding dish controls the cleaning device to conduct self-cleaning, specifically, controlling to start the control terminal corresponding to the cleaning device according to the predetermined cleaning device corresponding to the feeding dish, controlling the usage amount of the cleaning device so as to satisfy the required cleaning amount, in the meanwhile, controlling the sprinkling angle of the water sprinkler so as to conform with the required cleaning sprinkling angle, and drain the polluted water after cleaning by starting the cleaning processing device next to the feeding dish, specifically drainage operations comprise opening a drainage port so as to have the polluted water flow into a drainage box.

The intelligent drainage alarming module is configured to provide a siren on the pet drinking device, and in the meanwhile provide a liquid level sensor in the drainage box to monitor in real time the height of the liquid in the drainage box and compare the same with a predetermined alarming liquid level, when, at any moment, the height of the liquid is bigger than the predetermined alarming liquid level, starting the siren to send alarming signals and avoid outflow of the drainage due to too much liquid stored in the drainage box and pollution of the ground surface.

In an embodiment of the present invention, by providing the cleaning devices, the cleaning monitoring devices and the cleaning processing device on the feeding dish of the pet drinking device, collecting in real time images of the surface of the feeding dish with the cleaning monitoring terminals provided on the feeding dish of the pet drinking device, analyzing the cleaning index of the feeding dish based on the collected images of the surface of the feeding dish and conducting self-cleaning for the feeding dish, intelligent and automatic cleaning of the feeding dish in the pet drinking device is realized, compared with manual cleaning, limitations of time and place are overcome, well-targeted self-cleaning of the feeding dish can be done in real time, timeliness and well-targetedness of cleaning of the feeding dish is efficiently improved and cleaning effects are improved to some extent and feeding health of the pets can be promised in real time.

The foregoing are only some examples and explanation on structures of the present invention, those skilled in the art can make various modification, supplementation or substitution in similar ways to the embodiments of the present invention, and all the modification, supplementation and substitution shall fall into the protection scope of the present invention as long as they do not depart from the structures of the present invention or go beyond the range defined in the claims of the present invention.

1. A self-cleaning control system for pet drinking device based on Internet-of-Things, comprising:
a cleaning device setting module, configured to provide a cleaning device on a feeding dish of the pet drinking device and a control terminal thereof;
a cleaning monitoring terminal setting module, configured to provide a cleaning monitor terminal, wherein the cleaning monitor terminal comprises a ball-shaped monitor camera;
a cleaning device setting module, configured to provide a cleaning processing device next to the feeding dish of the pet drinking device;
a feeding dish pollution parameter monitoring module, configured to conduct image acquisition for a surface of the feeding dish with the cleaning monitoring terminal provided on the feeding dish of the pet drinking device, identifying types of dirt, dirty areas and spatial coordinates of the dirty areas;
a feeding dish cleaning index analysis module, configured to analyze a cleaning index of the feeding dish corresponding to pollution parameters of the surface of the feeding dish;
a control database, configured to store appearance features of dirt corresponding to all types of dirt, store cleaning types corresponding to all types of dirt, store a range of cleaning difficulty coefficients corresponding to all cleaning types; store cleaning water sprinkling amounts corresponding to all cleaning types for water cleaning and store required cleaning agent amounts and cleaning water sprinkling amounts corresponding to all cleaning types for chemical cleaning;
a feeding dish self-cleaning control terminal, configured to choose a predetermined cleaning device and cleaning demand for the feeding dish according to the cleaning index corresponding to the cleaning dish so as to control the predetermined cleaning device to conduct self-cleaning and open the cleaning processing device next to the feeding dish for drainage after cleaning.

2. The self-cleaning control system for pet drinking device based on Internet-of-Things according to claim 1, wherein the cleaning device comprises a cleaning liquid storage container and a water box, wherein a control terminal corresponding to the cleaning agent storage container is a control valve, a control terminal corresponding to the water box is a water sprinkler, wherein the water sprinkler is a sprinkler with water sprinkling angle adjustable.

3. The self-cleaning control system for pet drinking device based on Internet-of-Things according to claim 1, wherein the cleaning device comprises a drainage port and a drainage water box.

4. The self-cleaning control system for pet drinking device based on Internet-of-Things according to claim 1, wherein identifying the pollution parameters existing on the surface of the feeding dish according to images of the surface of the feeding dish comprises:
S1: focusing on the dirty area in the collected images of the surface of the feeding dish, extracting the appearance features of the dirt and a contour of the dirt;
S2: matching the extracted appearance features of the dirt and the contour of the dirt with all types of dirt in the control database and matching the types of dirt existing on the surface of the feeding dish;
S3: acquiring the dirty area existing on the surface of the feeding dish from the extracted contour of the dirt;
S4: building a three-dimensional rectangular coordinate system on the surface of the feeding dish by a predetermined building method of the three-dimensional rectangular coordinate system and locating spatial coordinates of the dirty area in the images of the surface of the feeding dish based on the three-dimensional rectangular coordinate system.

5. The self-cleaning control system for pet drinking device based on Internet-of-Things according to claim 1, wherein the cleaning index comprises cleaning types, cleaning difficulty levels and sprinkling angles, wherein the cleaning types comprise water cleaning and chemical cleaning.

6. The self-cleaning control system for pet drinking device based on Internet-of-Things according to claim 1, wherein analyzing the cleaning index corresponding to the feeding dish based on the pollution parameters on the surface of the feeding dish comprises the following steps:
(Step 1): extracting types of dirt from the pollution parameters, matching the types of dirt with all cleaning types corresponding to all types of dirt stored in the control database and obtaining the cleaning types corresponding to the feeding dish;
(Step 2): extracting the dirty area from the pollution parameters, extracting an area of the surface of the feeding dish from the images of the surface of the feeding dish, calculating the cleaning difficulty coefficient corresponding to the feeding dish by a cleaning difficulty coefficient calculation formula with the dirty area and the area of the surface of the feeding dish
$$Cleaning difficulty coefficient = \frac{dirty area}{area of the surface of the feeding dish} ;$$
(Step 3): comparing the cleaning difficulty coefficient with the range of the cleaning difficulty coefficients corresponding to the all cleaning difficulty levels in the control database and obtaining consequently the cleaning difficulty level corresponding to the feeding dish;
(Step 4): locating coordinates of an installation position of a water sprinkler based on the three-dimensional rectangular coordinate system, extracting spatial coordinates of the dirty area from the pollution parameters, analyzing desired sprinkling degrees of the water sprinkler to the dirty area according to coordinates of the installation position of the water sprinkler and the spatial coordinates of the dirty area, recording the same as a desired cleaning sprinkling degree, wherein an analysis process of corresponding desired cleaning sprinkling degrees Follows the following steps:
(Step 41): calculating a sprinkling distance between the water sprinkler and the dirty area according to the coordinates of the installation position of the water sprinkler and the spatial coordinates of the dirty area, and the sprinkling distance is marked as l;
(Step 42): taking as a starting point the installation position of the water sprinkler, drawing an installation horizontal line parallel to an axis x, projecting a position of the dirty area to the installation horizontal line, obtaining a projection position of the position of the dirty area on the installation horizontal line, marking the same as the projection position of the dirty area, obtaining coordinates of the projection position of the dirty area based on the three-dimensional rectangular coordinate system;
(Step 43): calculating a projection distance of the position of the dirty area based on the coordinates of the position of the dirty area and the coordinates of the projection position of the dirty area, and marking the projection distance as h;
(Step 44): forming a rectangular triangle with the installation position of the water sprinkler, the position of the dirty area and the projection position of the dirty area, calculating desired cleaning sprinkling angle based on the rectangular triangle, wherein a calculation formula of the desired cleaning sprinkling angle is
$$θ = arcsin \frac{h}{l} ,$$
θ is the desired cleaning sprinkling angle.

7. The self-cleaning control system for pet drinking device based on Internet-of-Things according to claim 1, wherein selecting a predetermined cleaning device and a desired cleaning amount corresponding to the feeding dish according to the cleaning index corresponding to the feeding dish comprises the following steps:
(1) Extracting cleaning types from the cleaning index, matching the cleaning types with the predetermined cleaning devices corresponding to all cleaning types, and selecting the predetermined cleaning device for the feeding dish;
(2) Extracting the cleaning difficulty level from the cleaning index, when the cleaning type corresponding to the feeding dish is water cleaning, the desired cleaning sprinkling amount is a water sprinkling amount, comparing the cleaning difficulty level with the desired water sprinkling amount corresponding to all cleaning difficulty levels for water cleaning stored in the control database, selecting the desired water sprinkling amount corresponding to the present cleaning difficulty level; if the cleaning type corresponding to the feeding dish is chemical cleaning, the desired cleaning amount comprises a cleaning agent usage amount and a desired water sprinkling amount, at this time, comparing the desired cleaning agent usage amount and the desired water sprinkling amount corresponding to all cleaning difficulty levels, and further obtaining the desired cleaning agent usage amount and the desired water sprinkling amount corresponding to the present cleaning difficulty level.

8. The self-cleaning control system for pet drinking device based on Internet-of-Things according to claim 7, wherein the desired cleaning devices corresponding to the predetermined cleaning types comprise specifically at least one water storage box for water cleaning and at least one cleaning agent storage box and at least one water storage box for chemical cleaning.

9. The self-cleaning control system for pet drinking device based on Internet-of-Things according to claim 1, wherein controlling the predetermined cleaning device to execute specific control methods corresponding to self-cleaning comprises specifically, starting the control terminal corresponding to the predetermined cleaning devices according to the desired cleaning device corresponding to the feeding dish, controlling a usage amount of the desired cleaning device so as to fulfill the cleaning demand, and controlling the sprinkling angle of the water sprinkler so as to comply with the desired cleaning sprinkling angle.

10. The self-cleaning control system for pet drinking device based on Internet-of-Things according to claim 1, wherein the system comprises further an intelligent drainage warning module, configured to provide a siren on the pet drinking device, in the meanwhile, installing a liquid level sensor in the drainage box, monitoring in real time height of a liquid level in the drainage box, and comparing the same with a predetermined warning liquid level, and if at any moment the liquid level is bigger than the predetermined warning liquid level, starting the siren to send warning.
